(19) United States
(12) Patent Application Publication
(10) Pub. No.: US 2020/0324149 A1
(43) Pub. Date: Oct. 15, 2020

(54) WEDGE DEVICES HAVING TEXTURED SURFACE CONTOURS

(71) Applicant: Carl H. Meyer, Murrells Inlet, SC (US)

(72) Inventor: Carl H. Meyer, Murrells Inlet, SC (US)

(21) Appl. No.: 16/380,230

(22) Filed: Apr. 10, 2019

(51) Int. Cl. A62B 3/00

(52) U.S. Cl. CPC A62B 3/005

(57) ABSTRACT

Wedge devices are provided which can be utilized for various applications including, for example, maintaining a purchase between a door and door jamb when performing a forcible door entry procedure. For example, a wedge device includes a wedge body having a tapered profile defined by a first surface and a second surface of the wedge body, and a handle coupled to a back-side of the wedge body. The first surface comprises a textured surface contour. The second surface may comprise a textured surface contour similar to the first surface, or a smooth contour. The textured surface contour(s) of the wedge body prevents backward slippage of the wedge device when in use, and the handle of the wedge device facilitates manipulation of the wedge device using one hand of an individual.

### TECHNICAL FIELD

The present disclosure generally relates to wedge devices that can be used for various applications such as forcible door entry procedures.

### BACKGROUND

In emergency situations, police, firefighters, and other first responders may need to forcibly enter a building or dwelling to gain access in order to save lives. One common method of forcible entry involves forcibly opening a locked door. To master the skill of forcible door entry, one should have a basic knowledge of the types and doors and security devices that may be encountered, as well as knowledge training in the types of tools that may be used for forcible door entry. First responders typically rely on a number of different devices to force entry to a building or vehicle. Prying tools, such as “Halligan” tools and crowbars are common tools used to breach doors and windows. A Halligan tool is a special tool which is commonly used by firefighters to perform prying, twisting, punching, or striking operations to break through the latch of a swinging door by forcing the Halligan tool between the door and door jamb (e.g., by striking the Halligan tool with a flat-head axe), and the using the Halligan tool to pry apart the door and doorjamb. An initial step of forcing an inward swinging door, for example, includes using the Halligan tool to “gap” the door and create a “purchase” between the door and the door stop/door jamb.

When performing forcible entry on a door, it is important to maintain the purchase that is gained at each stage of the forcible door entry process so that the Halligan tool and other tools can be repositioned to continue with the forcible door entry process. Typically, wood chock devices with smooth tapered surfaces are used by firefighters to maintain the gaps or purchases that are obtained during the forcible door entry process. However, the smooth tapered surfaces can cause the chock device to slip backwards out of position due to, e.g., opposing forces exerted on the smooth tapered surfaces of the chock device by the door and door jamb.

### SUMMARY OF THE INVENTION

Exemplary embodiments of the invention include wedge devices which can be utilized for various applications including, for example, maintaining a purchase between a door and door jamb when performing a forcible door entry procedure. For example, one exemplary embodiment includes a wedge device which comprises a wedge body having a tapered profile defined by a first surface and a second surface of the wedge body, and a handle coupled to a back-side of the wedge body. The first surface comprises a textured surface contour.

For example, in various exemplary embodiments, the textured surface contour of the first surface of the wedge body comprises one of a ridged surface contour, a barb-shaped surface contour, a stepped-shaped surface contour, a V-groove surface contour, and a ribbed surface contour. In other embodiments, the second surface of the wedge body comprises a textured surface contour or a smooth surface contour. The textured surface contour of the first surface and/or the second surface of the wedge body is configured to prevent backward slippage of the wedge device when in use.

Other embodiments will be described in the following detailed description of exemplary embodiments, which is to be read in conjunction with the accompanying figures.

### BRIEF DESCRIPTION OF DRAWINGS

FIGS. 1A, 1B, and 1C are schematic views of a wedge device according to an exemplary embodiment of the invention, which can be utilized to maintain a purchase between a door and door jamb when performing forcible entry on the door, wherein:

FIG. 1A is a schematic perspective view of the wedge device;

FIG. 1B is a schematic surface view of the wedge device; and

FIG. 1C is a schematic side view of the wedge device.

FIG. 2 illustrates a conventional Halligan forcible entry tool.

FIGS. 3A, 3B, and 3C schematically illustrate a method of utilizing a wedge device to maintain a purchase between a door and door jamb when performing forcible entry on the door, according to an exemplary embodiment of the invention.

FIGS. 4A, 4B, and 4C schematically illustrate wedge devices having textured surface contour profiles, according to alternative embodiments of the invention, wherein:

FIG. 4A schematically illustrates a wedge device having a wedge body which comprises stepped-shaped surface contours, according to an exemplary embodiment of the invention;

FIG. 4B schematically illustrates a wedge device having a wedge body which comprises V-groove surface contours, according to an exemplary embodiment of the invention; and

FIG. 4C schematically illustrates a wedge device having a wedge body which comprises ribbed surface contours, according to an exemplary embodiment of the invention.

FIG. 5 is schematic side view of a wedge device according to another exemplary embodiment of the invention.

FIG. 6 is schematic side view of a wedge device according to another exemplary embodiment of the invention.

### DETAILED DESCRIPTION OF EXEMPLARY EMBODIMENTS

Exemplary embodiments of the invention will now be discussed in further detail with regard to wedge devices which can be utilized, for example, to maintain a purchase between a door and door jamb when performing forcible entry on the door. It is to be understood that the various devices and structures shown in the accompanying drawings are schematic illustrations that are not drawn to scale. Moreover, the same or similar reference numbers are used throughout the drawings to denote the same or similar features, elements, or structures, and thus, a detailed explanation of the same or similar features, elements, or structures will not be repeated for each of the drawings. The term “exemplary” as used herein means “serving as an example, instance, or illustration”. Any embodiment or design described herein as “exemplary” is not to be construed as preferred or advantageous over other embodiments or designs.

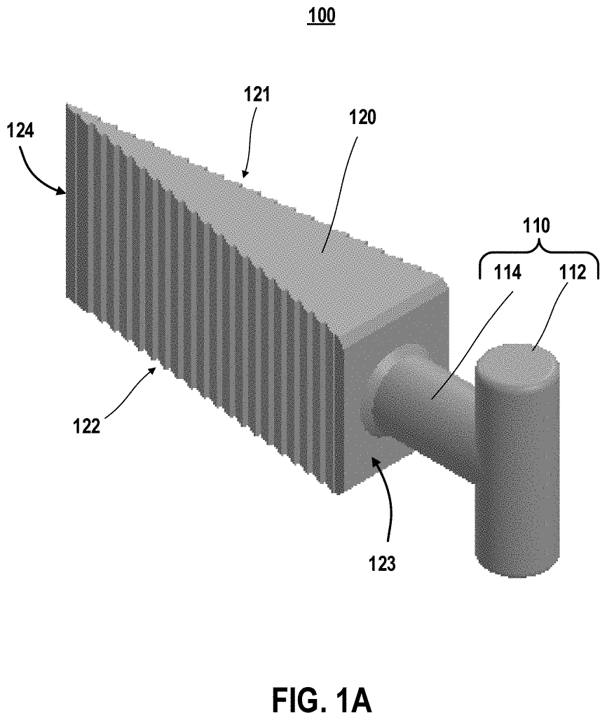

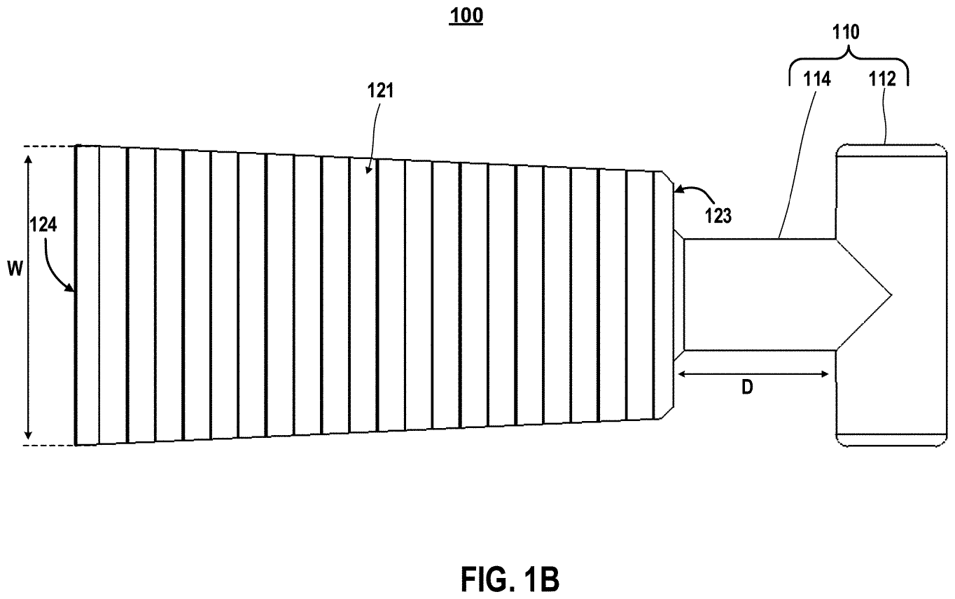

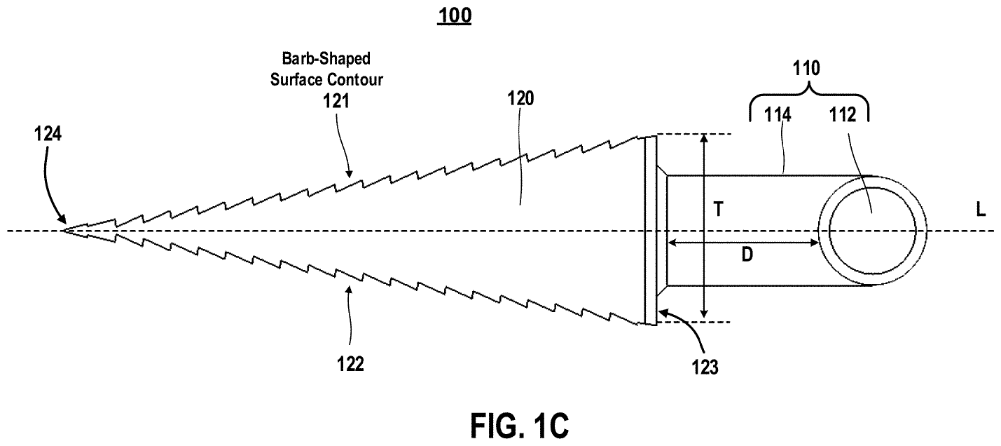

FIGS. 1A, 1B, and 1C are schematic views of a wedge device 100 according to an exemplary embodiment of the invention. FIG. 1A is a schematic perspective view of the wedge device 100, FIG. 1B is a schematic surface view of the wedge device 100, and FIG. 1C is a schematic side view of the wedge device 100. The wedge device 100 comprises a T-shaped handle structure 110, and a wedge body 120. The T-shaped handle structure 110 comprises a gripping handle 112 and an elongated stub element 114 which is coupled to the wedge body 120. The wedge body 120 comprises a tapered profile which is defined by a first textured surface 121 and a second textured surface 122 of the wedge body 120. The wedge body 120 comprises a back-side surface 123 and a front-side 124 (e.g., front-side edge).

In the exemplary embodiment shown in FIGS. 1A-1C, the first and second textured surfaces 121 and 122 are equal-length surfaces, which are angled with respect to a longitudinal axis L (shown in FIG. 1C) of the wedge device 100, and which extend from the back-side surface 123 of the wedge body 120 and converge at the front-side 124 of the wedge body 120. In this regard, as shown in FIG. 1C, the wedge body 120 comprises a triangular-shaped profile (in particular, an isosceles triangle shaped profile) which is defined by the first and second textured surfaces 121 and 122 and the back-side surface 123.

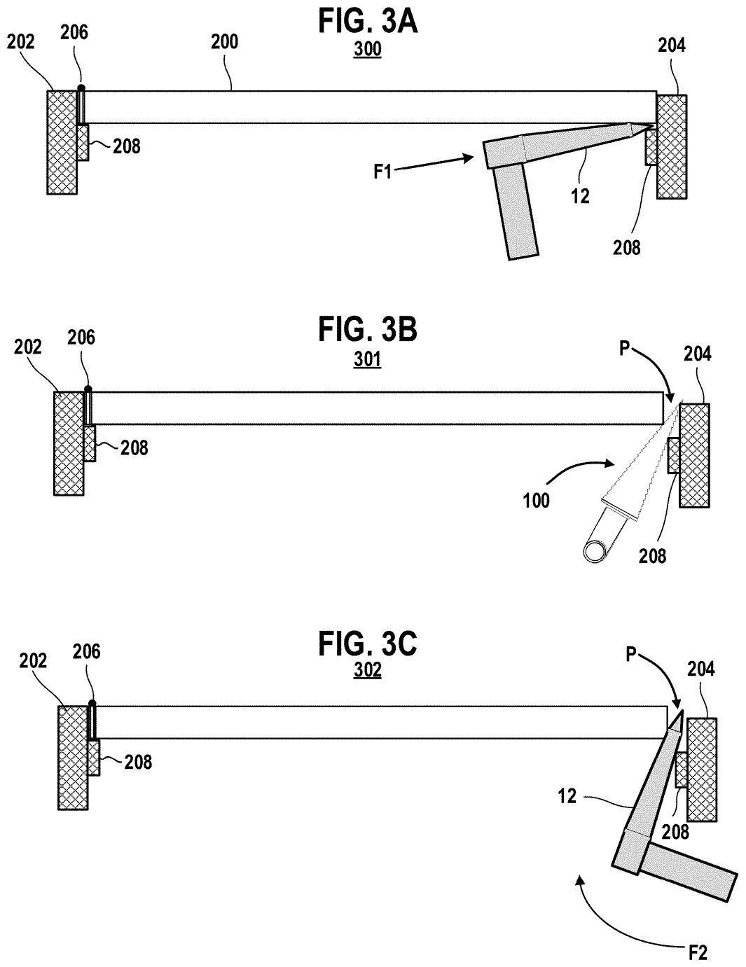

In the exemplary embodiment shown FIGS. 1A-1C, the first and second textured surfaces 122 and 122 each comprise a ridged surface contour (e.g., a barb-shaped surface contour) with the upper portions of the ridges facing backwards towards the T-shaped handle 110. The first and second textured surfaces 121 and 122 are configured to maintain the wedge device 100 in place when wedged, for example, between the edge of a door and a door jamb during a forcible door entry procedure, as explained in further detail below with reference to FIGS. 3A, 3B and 3C. The textured surface contours of the first and second textured surfaces 121 and 122 of the wedge body 120 are configured to prevent backward slippage of the wedge device 100 when wedged in position during use of the wedge device 100. This is in stark contrast to conventional chocks or wedge devices that have smooth surfaces, which can result in the chock or wedge device slipping backward from a wedged position.

The T-shaped handle 110 allows an individual to readily grip the gripping handle 112 and easily manipulate the wedge device 100 when pushing or jamming the wedge device 100 in position between objects, such as between the edge of a door and a door jamb during a forcible door entry process. As shown in FIGS. 1A-1C, the elongated stub element 114 extends from the back-side surface 123 of the wedge body 120 and maintains the gripping handle 112 at an offset distance D from the back-side surface 123 of the wedge body 120. For example, the distance D is designed to provide a sufficient amount of space for a firefighter wearing protective fire gloves to grasp the gripping handle 112 and allow the firefighter's gloved fingers to fit in the space between the gripping handle 112 and the back-side surface 123 of the wedge body 120.

In some embodiments, the wedge device 100 (and other wedge device embodiments described herein) are formed of a suitable rubber material which is weather resistance and heat resistant, for example, and manufactured using known compression molding techniques. In other embodiments, the exemplary wedge devices described herein can be formed of a suitable thermoplastic material and manufactured using compression molding techniques. In other embodiments, the exemplary wedge devices described herein can be formed of plastic or composite materials that are, e.g., weather resistant and heat resistant, using manufacturing techniques such as injection molding, for example, or CNC machining techniques. In some embodiments, the wedge devices are formed of a semi-rigid, compressible material which can be slightly compressed to augment or otherwise facilitate the functionality of the textured surfaces to maintain the wedge devices in place during use. In other embodiments, the wedge devices can be formed of a rigid material. The types of materials that are used to form wedge devices according to embodiments of the invention can vary depending on the primary intended use of the wedge devices.

Furthermore, the dimensions of the wedge device 100 can vary depending on the intended use. For example, for forcible door entry applications, in some embodiments, the distance D can be in a range of about 1.5 inches to about 2.0 inches, a width W (FIG. 1B) of the wedge body 120 can be in a range of about 1.0 inch to about 3.0 inches, and a thickness T (FIG. 1C) of the back-side 123 of the wedge body 120 can be in a range of about 1.0 inch to about 2.0 inches. In addition, in some embodiments, a length of the wedge body 120 between the back-side surface 123 and the front-side 124 can be in a range of about 5.0 inches to about 8.0 inches. It is to be understood that these dimensions are merely exemplary dimensions and should not be construed in any way to place limitations in the sizes and dimensions of wedge devices according to exemplary embodiments as described herein.

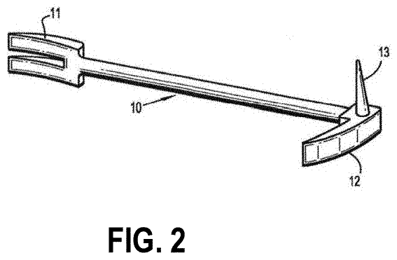

While the wedge device 100 (and other embodiments of wedge devices as described herein) may be utilized in various applications, for illustrative purposes, exemplary embodiments of the invention will be discussed in the context of using the wedge devices to maintain purchases that are obtained between a door and door jamb during a forcible door entry process. As is known in the art, first responders such as firefighters typically rely on a number of different devices to force entry to a building or vehicle. As noted above, prying tools, such as “Halligan” tools and crowbars are common tools used to breach doors and windows. For example, FIG. 2 schematically illustrates a conventional “Halligan” tool that is commonly used by firefighters for forcible door entry. The Halligan tool 10 comprises a claw (or fork) 11, a blade (wedge) 12 (which is commonly referred to as an ADZ end), and a tapered pick 13, which is especially useful in quickly forcing open many types of locked doors. Typically, a firefighter will utilize the ADZ end 12 or the fork end 11 of the Halligan tool 10 to break through the latch of a swinging door by forcing the ADZ end 12 or the fork end 11 between the door and door jamb by striking the Halligan tool 100 with a flat-head axe, for example, and then using the Halligan tool 10 to pry the apart the door and door jamb.

FIGS. 3A, 3B, and 3C schematically illustrate a method of utilizing a wedge device to maintain a purchase between a door and door jamb when performing forcible entry on the door, according to an exemplary embodiment of the invention. For example, FIGS. 3A-3C illustrate a method of using a wedge device (e.g., wedge device 100) for forcible entry of a right hand inward opening door using a Halligan tool, according to an exemplary embodiment of the invention. FIGS. 3A-3C schematically illustrate a top view of an inward swinging door 200, door jambs 202 and 204, hinges 206, and door stops 208. FIG. 3A schematically depicts an initial step (300) in forcing the inward operating door 200 by utilizing the ADZ end 12 of the Halligan tool 10 to “gap” the door 200 and create a “purchase” between the door 200 and the door stop 208 on the handle/lock side of the door 200. With this process, an individual would forcibly insert the ADZ end 12 of the Halligan tool between the edge of the door 200 and the door stop 208 by applying a blunt force F1 (via an axe or maul) against the back-side of the ADZ end 12. The individual would then push up or down on the Halligan bar causing the ADZ end 12 to rotate and crease the door 200 and create a gap between the door 200 and the stop 208 (e.g., bend the door edge or stop and create a purchase), which initiates the start of applying a breaking force to the door latch or lock.

FIG. 3B illustrates a next step (301) in the process of forcing the inward opening door 200 using the wedge device 100 to maintain a purchase P (or gap, space) that is obtained between the edge of the door 200 and the door stop 208 and/or door jamb 204. Various techniques and steps can be utilized to obtain the purchase P using a Halligan tool and other tools, the details of which are well known and not necessary for understanding the inventive aspects of the embodiments described herein. As the Halligan tool and/or other tools are manipulated to spread the edge of the door 200 further away from the door jamb 204, the individual (e.g., firefighter, first responder, etc.) will maintain the obtained purchase P by inserting the wedge device 100 into the gap/space between the door 200 and the jamb 204, as schematically illustrated in FIG. 3B.

In this process, the wedge device 100 maintains the obtained gap/space (or purchase P) while the forcible entry tools (e.g., Halligan tool) are manipulated and repositioned as needed to proceed with the forcible door entry procedure. The T-shaped handle 110 allows the individual to easily grip the wedge device 100 in one hand and forcibly push or jam the wedge body 120 further into the current gap (or purchase P), while the textured surfaces 121 and 122 of the wedge body 120 (coupled with the slight compression of the textured surfaces when the wedge body 120 is formed of a semi-rigid, compressible material) serve to maintain the inserted wedge device 100 in place and not slip backwards out of the gap. As a larger gap (or purchase P) is gained by further operation of the forcible entry tool(s), the individual can grip the T-handle 110 and further push/jam the wedge device 100 into the gap and maintain the newly obtained spacing, and repeat the process as more purchase is gained.

FIG. 3C schematically illustrates a next step (302) in the forcible door entry process where the ADZ end 12 of the Halligan tool 10 is inserted into the obtained gap/space (e.g., purchase P) between the door 200 and the door jamb 204 while the wedge device 100 (not shown) is disposed in the gap/space at a position either above or below the inserted position of the ADZ end 12, and the Halligan tool 10 is forcibly rotated in a direction (as illustrated by an arrow F2 in FIG. 3C) to create leverage against the door 200 and attempt to forcibly break the door lock and/or door jamb 204 and force the inward swinging door 200 open.

It is to be appreciated that the wedge device 100 provides various advantages over conventional chock devices (e.g., tapered wood chocks) that may be used when performing a forcible door entry procedure. For example, the T-handle 110 of the wedge device 100 allows an individual to easily manipulate the wedge device 100 by forcibly pushing/jamming the wedge body 120 into the gap between the door and door jamb using one hand. Conventional chock devices (e.g., wood chocks) are not equipped with a handle, and typically require the use of a striking tool to tap the back-side of the chock device with a blunt force to firmly position the chock device in position. Moreover, as noted above, a conventional chock device has smooth tapered surfaces which can cause the chock device to slip backwards out of position due to, e.g., opposing forces exerted on the smooth tapered surfaces of the chock device by the door and door jamb (or other elements between which the chock device is inserted).

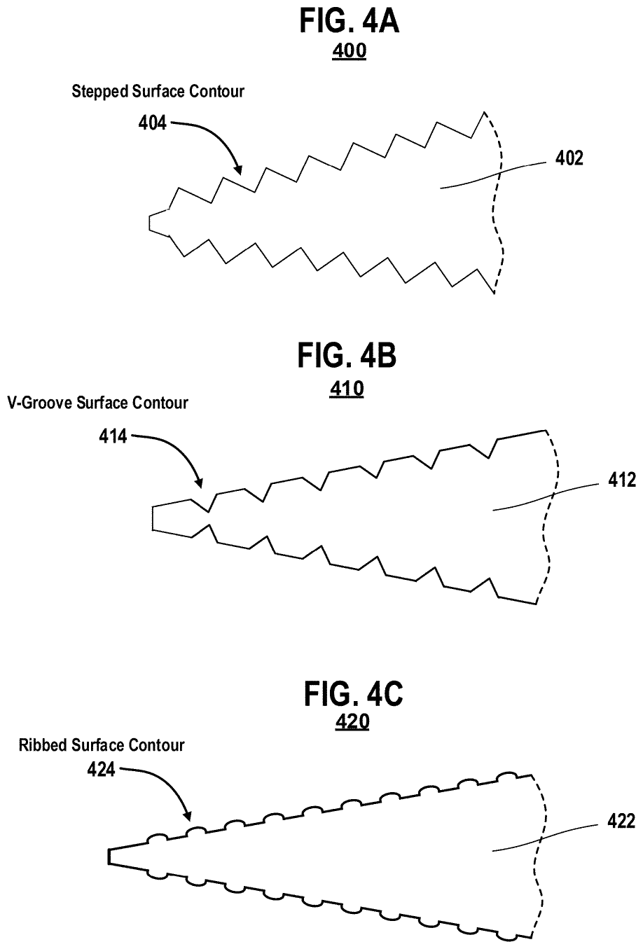

While FIGS. 1A-1C illustrate an exemplary embodiment in which the textured surfaces 121 and 122 of the wedge body 120 have a ridged surface contour (e.g., a barb-shaped surface contour), it is to be appreciated that other types of textured surface contours may be implemented to provide sufficient gripping of the tapered surfaces of the wedge body 120 to prevent slippage of the wedge device 100. For example, FIGS. 4A, 4B, and 4C schematically illustrate wedge devices having different textured surface contour profiles according to alternative embodiments of the invention. In particular, FIG. 4A schematically illustrates a wedge device 400 having a wedge body 402 which comprises stepped-shaped surface contours 404, according to an exemplary embodiment of the invention. Further, FIG. 4B schematically illustrates a wedge device 410 having a wedge body 412 which comprises V-groove surface contours 414, according to an exemplary embodiment of the invention. Moreover, FIG. 4C schematically illustrates a wedge device 420 having a wedge body 422 which comprises ribbed surface contours 424, according to an exemplary embodiment of the invention. It is to be understood that the textured surface contours/profiles as described herein are merely exemplary illustrations of different textured surfaces that can be utilized to prevent backward slippage of the wedge devices, and that other types of textured surfaces may be implemented which are suitable for the intended purpose of preventing slippage of the wedge device.

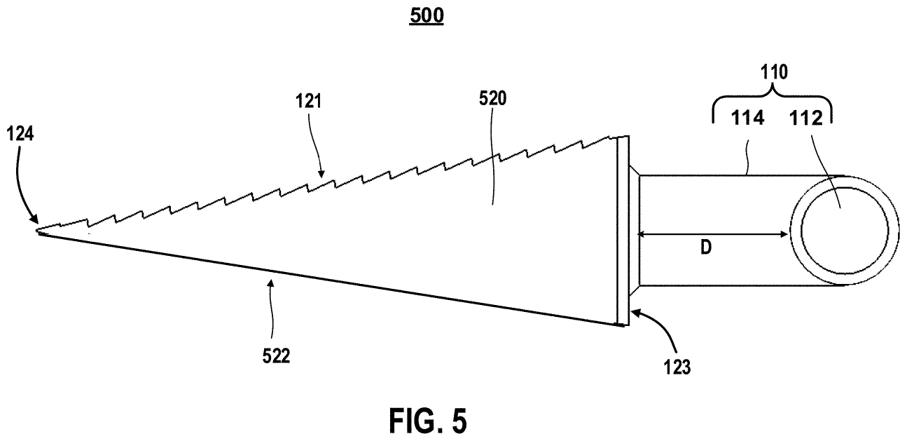

In other embodiments, wedge devices can be designed with different wedge body shapes and/or with only one textured surface. For example, FIG. 5 is schematic side view of a wedge device 500 according to another exemplary embodiment of the invention. The wedge device 500 is similar to the wedge device 100 of FIGS. 1A-1C, except that a wedge body 520 of the wedge device 500 in FIG. 5 comprises only one textured surface 121 and a smooth angled surface 522. In some embodiments and applications, a wedge body having a single textured surface would be sufficient to prevent backward slippage of the wedge device.

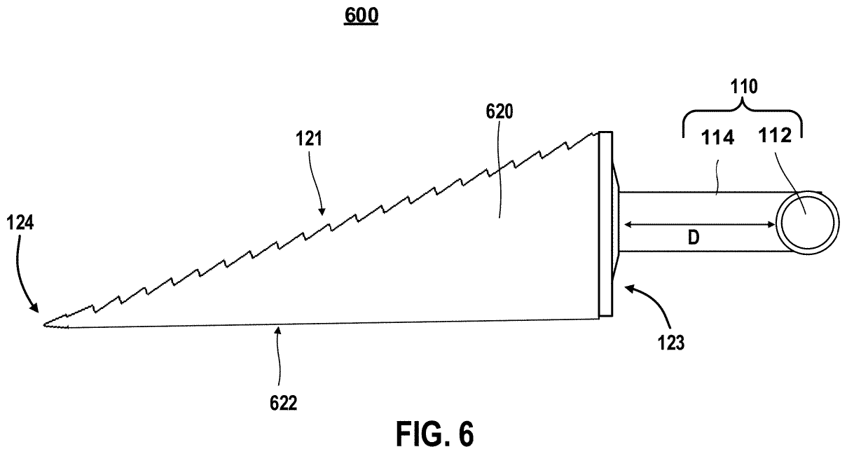

Further, FIG. 6 is schematic side view of a wedge device 600 according to another exemplary embodiment of the invention. The wedge device 600 comprises a wedge body 620 having only one textured surface 121 and a smooth surface 622. In addition, the wedge body 620 in FIG. 6 comprises a right-triangle shaped profile, as compared to the isosceles triangle shaped profiles of the wedge bodies shown in FIGS. 1A-1C, 4A, 4B, 4C, and 5.

Although exemplary embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

1. A wedge device, comprising:
a wedge body comprising a tapered profile defined by a first surface and a second surface of the wedge body; and
a handle coupled to a back-side of the wedge body;
wherein the first surface comprises a first textured surface contour; and
wherein the second surface comprises a second textured surface contour.

2. The wedge device of claim 1, wherein the handle comprises a T-shaped handle comprising an elongated stub element and a gripping handle, wherein a first end of the elongated stub element is coupled to the back-side of the wedge body and wherein a second end of the elongate stub element is coupled to the gripping handle.

3. The wedge device of claim 1, wherein the first and second textured surface contours of the respective first and second surfaces of the wedge body each comprise a ridged surface contour.

4. The wedge device of claim 1, wherein the first and second textured surface contours of the respective first and second surfaces of the wedge body each comprise a barb-shaped surface contour.

5. The wedge device of claim 1, wherein the first and second textured surface contours of the respective first and second surfaces of the wedge body each comprise a stepped-shaped surface contour.

6. The wedge device of claim 1, wherein the first and second textured surface contours of the respective first and second surfaces of the wedge body each comprise a V-groove surface contour.

7. The wedge device of claim 1, wherein the first and second textured surface contours of the respective first and second surfaces of the wedge body each comprise a ribbed surface contour.

8.-10. (canceled)

11. The wedge device of claim 1, wherein the wedge body comprises an isosceles triangle shaped profile.

12. The wedge device of claim 1, wherein the wedge body comprises a right triangle shaped profile.

13. The wedge device of claim 1, wherein the wedge body is formed of a rubber material.

14. The wedge device of claim 1, wherein the wedge body is formed of a rigid plastic material.

15. The wedge device of claim 1, wherein the wedge body is formed of a semi-rigid plastic material.

16. The wedge device of claim 1, wherein the wedge device is a unitary injection-molded device.

17. The wedge device of claim 1, wherein the wedge device is a unitary compression-molded device.

18. A wedge device, comprising:
a wedge body comprising a tapered profile defined by a first surface and a second surface of the wedge body, wherein the first and second surfaces each comprise a textured surface contour; and
a handle coupled to a back-side of the wedge body;
wherein the wedge body comprises an isosceles triangle shaped profile; and
wherein the wedge body is formed of a compressible rubber material.

19. The wedge device of claim 18, wherein the textured surface contours of the respective first and second surfaces of the wedge body each comprise a ridged surface contour.

20. The wedge device of claim 18, wherein the textured surface contours of the respective first and second surfaces of the wedge body each comprise a barb-shaped surface contour.

21. The wedge device of claim 18, wherein the textured surface contours of the respective first and second surfaces of the wedge body each comprise a stepped-shaped surface contour.

22. The wedge device of claim 18, wherein the textured surface contours of the respective first and second surfaces of the wedge body each comprise a V-groove surface contour.

23. The wedge device of claim 18, wherein the textured surface contours of the respective first and second surfaces of the wedge body each comprise a ribbed surface contour.
